(19) United States
(12) Patent Application Publication
(10) Pub. No.: US 2007/0267842 A1
(43) Pub. Date: Nov. 22, 2007

(54) PICK-UP TRUCK STOWABLE ACCESS STEP ASSEMBLY

(75) Inventors: Nicholas Arthur Seibert, Edgerton, OH (US); Anthony Paul Voegeli, Fort Wayne, IN (US)

Correspondence Address: Peter D. McDermott;Banner & Witcoff, LTD, 28th Floor, 28 State Street, Boston, MA, 02109, US

(73) Assignee: Dura Automotive Systems, Inc., Rochester Hills, MI (US)

(21) Appl. No.: 11/748,904

(22) Filed: May 15, 2007

Related U.S. Application Data
(60) Provisional application No. 60/800,717, filed on May 16, 2006.

(51) Int. Cl. B60R 3/00

(52) U.S. Cl. 280/166

(57) ABSTRACT

In one aspect a pick-up truck comprises a truck body with a rear cargo bed and a stowable access step mounted for movement between a stowed position and an extended position. The access step has a tread portion dimensioned to receive at least one human foot and can be used, at least in the extended position, for stepping up for better access to the cargo bed. Optionally, the stowable access step is configured to form, in the stowed position, a portion of a running board. One or more stowable access steps can be provided on each side of the cargo bed. In another aspect, a stowable access step assembly is provided, having a first mounting structure configured to be fixedly integrated with the bed of a pick-up truck and a second mounting structure mounted for sliding or other movement relative to the first mounting structure. The access step is integral with the second mounting structure and moveable with the second mounting structure between an extended position and a stowed position.

### PRIORITY CLAIM

This application claims priority to U.S. Provisional Patent Application Ser. No. 60/800,717 filed on May 16, 2006, hereby incorporated by reference in its entirety for all purposes.

### INTRODUCTION

The present invent relates to improved access to the cargo beds of pick-up trucks. In particular, the invention relates to stowable access step assemblies for pick-up trucks.

### BACKGROUND

Pick-up trucks are known to have cargo beds useful for hauling and storing items, such as luggage, tools, equipment, supplies, etc. While the cargo beds of pick-up trucks often have tailgates which can be opened for better access, it often is desirable to place items into the bed or to remove them without opening the tailgate, that is, by lifting the items over the side walls. For example, it may be inconvenient to open the tailgate.

In some cases, however, lifting items over the side walls is difficult. Especially in larger pick-up trucks, the beds are positioned higher or the walls of the bed have a larger vertical dimension. It may be desirable, in some cases, to have an improved view into the cargo bed without having to open the tailgate.

There is a need, therefore, to provide improved access to cargo beds of pick-up trucks, especially for placing items into the bed or removing items without opening the tailgate, or for improved view into the bed. Accordingly, it is an object of the present invention to provide improved access to cargo beds of pick-up trucks. Additional objects and advantages of the invention, or of selected aspects or embodiments of the invention, will be understood by those skilled in this field of technology in view of the following disclosure and in view of the description provided of certain exemplary embodiments.

### SUMMARY

In accordance with a one aspect, a pick-up truck stowable access step assembly comprises an access step having a tread portion dimensioned to support at least one human foot, and deployment structure configured to integrate with a pick-up truck. The deployment structure comprises at least one access step mounting member configured for movement relative to the cargo bed of the pick-up truck. The access step is integral with the access step mounting member of the deployment structure and is moveable back and forth (typically in and out) between an extended position and a stowed position.

In accordance with a one aspect, a pick-up truck stowable access step assembly comprises a first mounting structure, a second mounting structure and an access step integral with the second mounting structure. The first mounting structure is configured to be fixedly integrated with the bed of a pick-up truck. The second mounting structure is mounted to the first mounting structure for movement relative to the first mounting structure. In certain exemplary embodiments, for example, the first mounting structure employs one or more hollow structural tubes, such as square tubes (i.e., tubes having a square cross-section) with 0.125 inch wall thickness, and the second mounting structure employs smaller hollow structural tubes that are slidably received longitudinally (i.e., axially) into the tubes of the first mounting structure. The stowable access step is integral with the second mounting structure and is moveable with the second mounting structure between an extended position and a stowed position. Optionally, the access step is mounted in fixed orientation relative to the second mounting structure. The stowable access step has a tread portion dimensioned to support at least one human foot. As used here (meaning in this disclosure and discussion of the inventive subject matter and in the appended claims) “stowable” means retractable or otherwise moveable to a recessed or stowed position from a position in which it is readily usable as a supporting step for a person accessing the pick-up truck's bed, e.g., to put items into the bed or to lift items from the bed over the side wall or rear tailgate of the pick-up truck.

In certain exemplary embodiments the stowable access step can be deployed by foot, e.g., by stepping on a deployment bar associated with the access step. It will be recognized that deployment members may be configured other than as a bar, but for convenience, all such alternative configurations will be referred to here as a deployment bar. In other exemplary embodiments the stowable access step is motor driven and can be operated by switch, e.g., a hard-wired or wireless switch. A wireless switch can be integrated into a key fob for the vehicle. A hard-wired switch can be positioned remotely at any convenient location, e.g., in the passenger compartment, on the exterior of a body panel, etc. It should be understood that in certain exemplary embodiments the stowable access step may be useable in the stowed position. In certain exemplary embodiments the stowable access step may have a single extended position, and in other exemplary embodiments it may have a series of 2 or more extended positions to which it can be moved from the stowed position.

In certain exemplary embodiments the travel distance between the stowable access step's stowed position and its first, last or only extended position is at least about 3 or 4 inches, typically about 3 inches to 7 inches, depending at least somewhat on the size and configuration of the pick-up truck. For example, the travel distance can be 4 inches to 6 inches, e.g., about 5 inches. Deployed to its extended position, the stowable access step is conveniently useable as a step for a person seeking improved access to the cargo bed of a pick-up truck, e.g., for placing items into the bed or removing items without opening the tailgate, or for viewing into the cargo bed. In its stowed position, the access step is conveniently out of the way. In certain exemplary embodiments the stowable access step can be attractively integrated into the exterior design of the pick-up. For example, employed in a pick-up truck having a running board extending fore-and-aft along at least a portion of the cargo bed, the stowable access step can be configured to form, in the stowed position, a portion of the running board. Optionally, so much of the stowable access step as is readily visible can be configured to mimic the look and dimensions of the adjacent running board (or other adjacent features of the pick-up truck), so as to have an attractive and built-in appearance.

Optionally, the stowable access step assembly further comprises a locking mechanism operative to releasably hold the second mounting structure or at least the access step in the stowed position. In certain exemplary embodiments the locking mechanism is operative to releasably hold the second mounting structure to the first mounting structure in the stowed position. Such locking mechanisms can aid in preventing unintended deployment of the stowable access step. A release mechanism can be provided to release the access step to travel to the deployed position. In certain exemplary embodiments employing a first and second mounting structure as described above, the release mechanism is operative to release a latch or the like of the locking mechanism, such that the stowable access step and the second mounting structure travel to the deployed position. In certain exemplary embodiments the release mechanism can comprise a hand- or foot-operable handle mounted to the second mounting structure (indirectly, e.g., via the stowable access step, or directly), which is operative to release the second mounting structure from the stowed position. The aforesaid foot-operable release bar can serve as the operating handle of the release mechanism. In certain exemplary embodiments employing a first and second mounting structure as described above, a foot-operable release bar is pivotably mounted to the second, i.e., moveable mounting structure, and is biased toward a latching position. The release bar presents outwardly (i.e., for ready access by the user) a lever or bar segment or the like to be depressed by foot action. The opposite end of the release bar in such embodiments can be a latch end, e.g., a free end of the release bar that is simply bent downwardly to be received in a recess in a fixed-position structure, e.g., in a recess in the first mounting structure of the assembly. For example, the latch end can extend, in its latched position, through an access hole in the second mounting structure into a hole or other recess in the first mounting structure. A spring, gravity or the like, e.g., a spring mounted at the pivot of the release bar, can bias the release bar toward its latching position. In operation of such embodiments, depressing the outward bar segment (by foot or otherwise) raises the latch end of the release bar against the spring bias, thereby lifting the latch end out of the recess and freeing the access step to move to its deployed position.

With or without the just described locking and release mechanisms, the assembly optionally further comprises a deployment-hold, that is, a mechanism or feature that is operative to releasably hold or bias the access step in the extended position, alternatively referred to as an extension-hold or the like. In certain exemplary embodiments wherein the deployment-hold mechanism is operative to bias the access step in the extended position, it may comprise at least a compression spring which is compressed when the access step is in the stowed position. Thus, for example, in embodiments having a locking mechanism as described above, releasing the locking mechanism allows the compressed spring to push the access step toward its deployed position. In certain exemplary embodiments the deployment-hold further comprises a strut, such as a pneumatic strut, a stop surface to limit the travel range of the access step toward the deployed position, or both. The strut can aid in controlling the position and/or speed of travel of the access step in either or both directions. The stop surface can establish a travel limit for the access step in the deployed position. Additional suitable mechanisms to hold the step in the deployed position will be apparent to those skilled in the art in view of the present disclosure. The extension-hold in certain exemplary embodiments comprises a spring-biased latch, a detent that receives a moveable member, a stop surface, etc. Numerous suitable alternatives will be apparent to those of ordinary skill in the art given the benefit of this disclosure.

In certain exemplary embodiments the pick-up truck stowable access step assembly is electrically powered. Typically, such embodiments comprise an electric motor and a drive member driven by the motor and operably connected to the second mounting structure to move the mounting structure back and forth (in and out) between the extended position and the stowed position. Optionally, the assembly further comprises a gearbox. The drive member can be a lead screw (a threaded shaft), the gearbox being operably connected between the motor and the lead screw to control at least the direction of driven movement of the second mounting structure. In certain exemplary embodiments the assembly further comprises a sensor operative to generate a signal corresponding to the movement or position of the second mounting structure. The signal can be received by the motor, the motor's power source, or by an associated controller, e.g., a microprocessor or the like, to control operation of the motor.

In accordance with another aspect of the invention, a pick-up truck comprises a truck body having a rear cargo bed and a stowable access step assembly. The stowable access step assembly comprises an access step mounted for movement between a stowed position and an extended position. A tread portion of the access step is dimensioned to receive at least one human foot. In certain exemplary embodiments the access step assembly is sufficiently robust that the access step in the extended position can bear at least a 300 pound load applied downwardly on the tread portion. In certain exemplary embodiments it can bear at least 500 pounds or even at least 600 pounds. Typically, the access step is mounted for substantially horizontal, lateral movement between the extended position and the stowed position. As used here “lateral” means side-to-side with reference to the pick-up truck body. That is, lateral means perpendicular to fore-and-aft, where the cargo bed is aft of the passenger compartment. Also, “substantially horizontal” means horizontal and optionally also somewhat fore-and-aft and/or vertical, e.g., horizontal with a smaller vertical drop into a secure position when deployed.

In certain exemplary embodiments the pick-up truck further comprises a second stowable access step assembly comprising a second access step mounted for movement between a stowed position and an extended position. The second stowable access step has a tread portion dimensioned to receive at least one human foot. In certain exemplary embodiments the second access step in the extended position is sufficiently robust to bear at least a 300 pound load applied downwardly on the tread portion. While the one or more stowable access steps can deploy from any location around the cargo bed, e.g., the sides or rear of the bed, in exemplary embodiments having two or more stowable access steps the first preferably is mounted at a first side of the cargo bed for substantially horizontal, lateral movement between the stowed position and the extended position, and the second stowable access step preferably is mounted at the opposite side of the cargo bed for substantially horizontal, lateral movement between its stowed position and its extended position.

It will be appreciated by those skilled in the art, that is, by those having skill and experience in the technology areas relevant to the pick-up truck stowable access step assemblies disclosed here, that significant advantages can be provided by such assemblies and by pick-up trucks incorporating one or more such assemblies. Improved access is provided to pick-up truck cargo beds by at least certain exemplary embodiments, including, but not limited to, those further described below. Various embodiments of the stowable access step assemblies disclosed here are suitable to provide convenience and improved functionality. Additional advantages will be apparent to those skilled in the art given the benefit of this disclosure.

### BRIEF DESCRIPTION OF THE INVENTION

Certain exemplary embodiments of the inventive subject matter disclosed here will be described in more detail with reference to the appended drawings wherein:

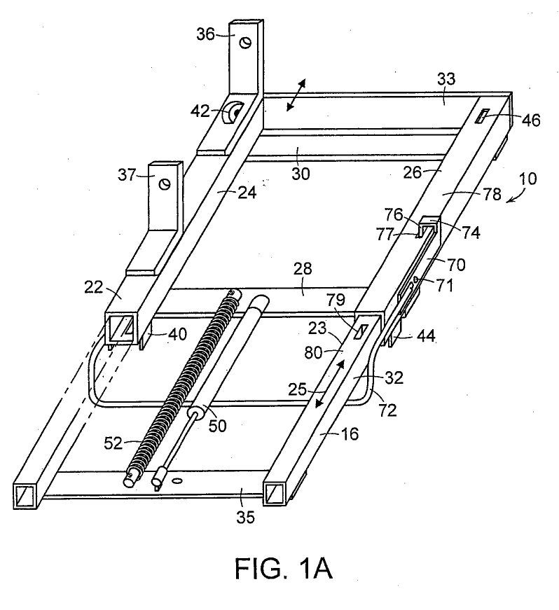

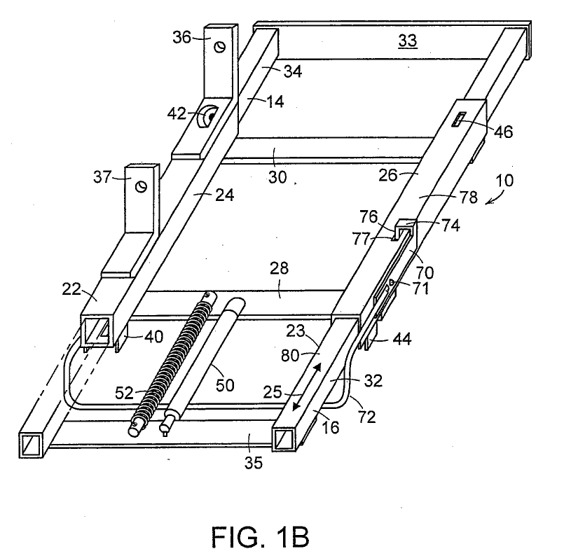

FIG. 1A is a schematic perspective view, partially broken way, of a pickup truck stowable access step assembly in accordance with one embodiment of the present disclosure, comprising a release mechanism including a release bar and extension-control features, shown in the extended or deployed position;

FIG. 1B is a schematic perspective view, partially broken way, of the pickup truck stowable access step assembly of FIG. 1A, shown in the stowed position;

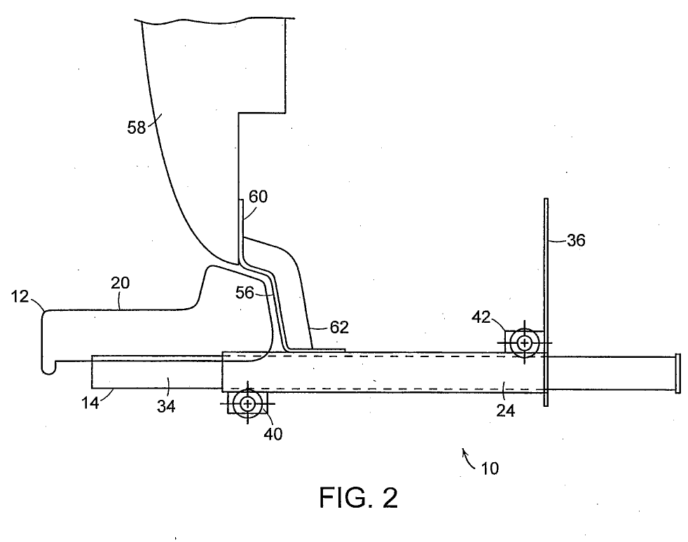

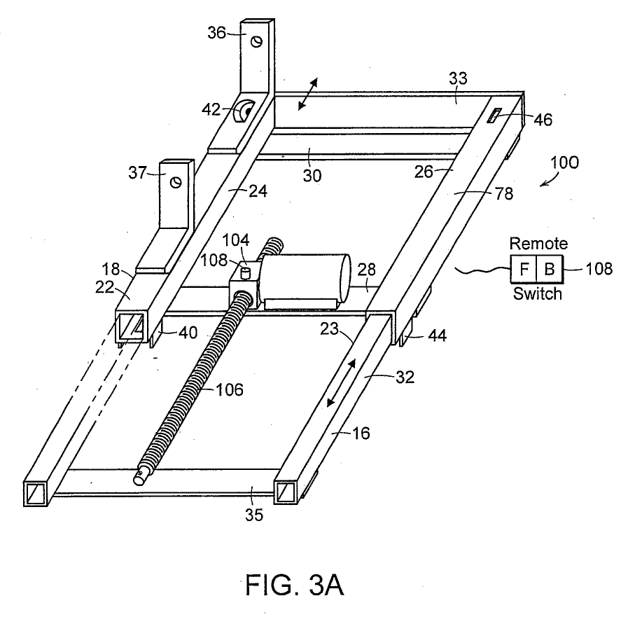

FIG. 2 is a side elevation view, partially broken away and partially in section, of the FIG. 1 embodiment of the pickup truck stowable access step assemblies disclosed here;

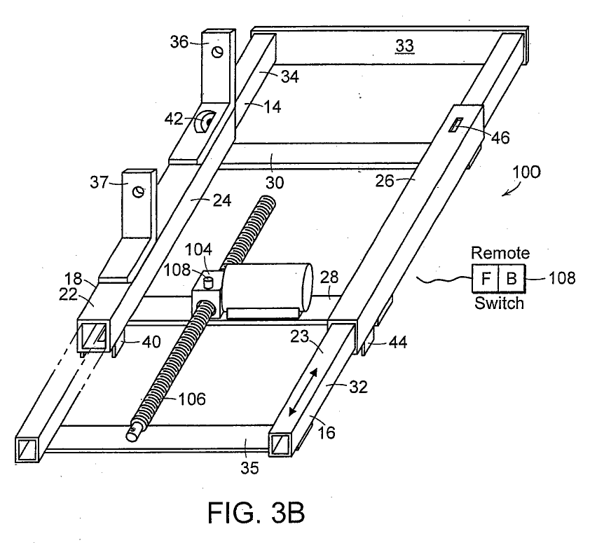

FIG. 3A is a schematic perspective view, partially broken way, of a pickup truck stowable access step assembly in accordance with a power driven embodiment of the present disclosure, shown in the extended position;

FIG. 3B is a schematic perspective view, partially broken way, of the pickup truck stowable access step assembly of FIG. 3B, shown in the stowed position;

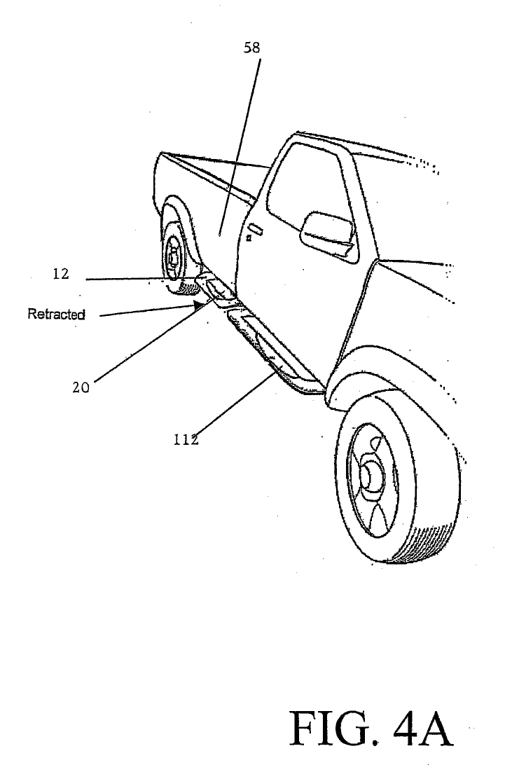

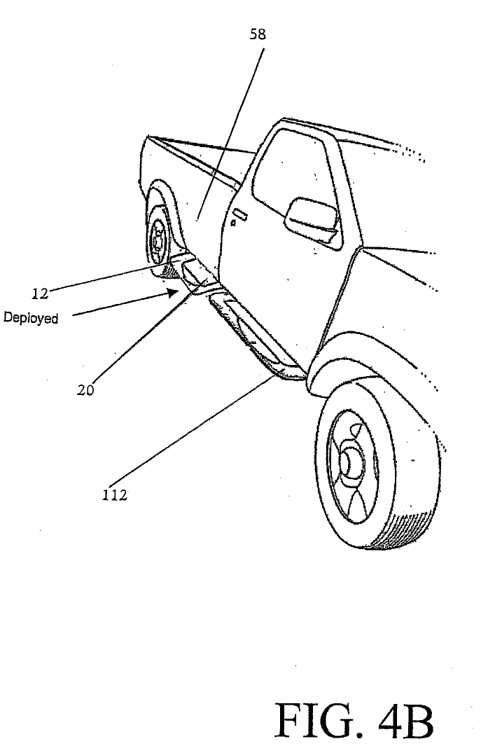

FIG. 4A is a perspective view, partially broken away and partially in section, of the embodiment of FIGS. 1A and 1B, showing the stowable access step configured to form, in the stowed position, a portion of the running board of the pick-up truck; and

FIG. 4B is a perspective view, partially broken away and partially in section, of the embodiment of FIG. 4A, shown in the extended position.

The figures referred to above should be understood to provide a representation of certain exemplary embodiments of the invention, illustrative of the principles involved. In some cases the same reference numbers may be used in drawings for similar or identical components and features shown in various alternative embodiments. Suitable configurations, dimensions, orientations and the like for any particular embodiment of the stowable access step assemblies will typically be determined, at least in part, by the intended application, including the configuration, dimensions and materials of the pick-up truck with which the assembly is to be used.

### DETAILED DESCRIPTION OF CERTAIN EXEMPLARY EMBODIMENTS

It will be apparent to those of ordinary skill in the art, given the benefit of this disclosure, that there are numerous alternative embodiments of the inventive subject matter disclosed here. For purposes of convenience, the discussion below will focus primarily on certain exemplary embodiments of the pick-up truck stowable access step assemblies disclosed here. It should be understood that the principles of operation, system details, optional and alternative features, etc. are generally applicable as well to other embodiments.

The pick-up truck stowable access step assemblies in accordance with certain advantageous embodiments can be designed to be sufficiently robust even to support an individual holding one or more heavy items to be placed into (or removed from) the cargo bay. For example, certain exemplary embodiments of the pick-up truck stowable access step assembly employ first and second mounting structures, each in the form of a rigid frame, the second mounting structure carrying the access step and being mounted for movement relative to the first mounting structure. Numerous suitable designs for such embodiments will be apparent to those of ordinary skill in the art given the benefit of this disclosure. For example, the framework of the first mounting structure can comprise a first stationary longitudinal tube, a second stationary longitudinal tube spaced from and parallel to the first stationary longitudinal tube, and optionally cross-members interconnecting the first and second stationary longitudinal tubes. Similarly, the framework of the second mounting structure can comprise a first extendable longitudinal tube, and a second extendable longitudinal tube spaced from and parallel to the first extendable longitudinal tube and, optionally, cross-members interconnecting them. The first and second extendable longitudinal tubes in such embodiments can be slidably mounted to the first and second stationary longitudinal tubes, respectively, for longitudinal movement of the first and second extendable longitudinal tubes relative to the first and second stationary longitudinal tubes during deployment and stowing of the access step. It should be understood that the “stationary” tubes are referred to as stationary because they are (or are designed and intended to be) integrated to the frame or body of the pick-up truck in a stationary position, e.g., mounted under the cargo bay, etc. In embodiments of this general type, the extendable longitudinal tubes can telescope in and out of the stationary longitudinal tubes or can be otherwise received longitudinally by (e.g., into, onto, under, etc.) the stationary longitudinal tubes, for deployment and stowing of the access step. In certain exemplary embodiments the stationary longitudinal tubes of the first mounting structure can be square cross-section tubes, and the extendable longitudinal tubes can comprise square cross-section tubes of slightly smaller cross-sectional dimensions, which are slidably received longitudinally into the stationary longitudinal tubes, respectively. For laterally deployable access steps (i.e., access steps that come out to the right or left side of the pick-up truck) the longitudinal tubes typically are positioned horizontally under the cargo bay and oriented laterally, i.e., perpendicular to the fore-and-aft direction of the pick-up truck.

Numerous alternative locations and designs for integrating the stowable access step in the pick-up truck will be readily apparent to those of ordinary skill in the art given the benefit of this disclosure. For example, in embodiments using a moveable mounting frame with a stationary mounting frame, certain alternative embodiments employ just a single centered stationary rail with a corresponding single sliding rail rather than the two pairs of rails described above. Such single rail designs can provide cost, weight, and packaging space reduction.

Optionally, bearings can be operatively interposed between the first mounting structure and the second mounting structure, e.g., in embodiments constructed as just described with longitudinal tube members of the second mounting structure sliding relative to those of the first mounting structure, upper and lower bearings can be used at one or more locations along each pair of tubes. Numerous alternative designs for the bearings will be readily apparent to those of ordinary skill in the art given the benefit of this disclosure.

As mentioned above, certain exemplary embodiments of the pickup truck stowable access step assemblies disclosed here are powered. That is, they comprise an electric drive mechanism, such as an electric motor or the like to deploy and retract the access step. The unit can be driven from the closed or stowed position to the extended position through the use of a small motor, e.g., a 12 volt electric motor run on the main vehicle power system or a separate, dedicated power system with a battery and/or generator. In addition, such embodiments can also comprise suitable gearing, e.g., a planetary or worm drive gear set, optionally housed in a gearbox. An output member, e.g., a lead screw or the like is connected directly to the access step or, alternatively, to a component of a movable deployment structure. Numerous alternative drive mechanism designs will be readily apparent to those of ordinary skill in the art given the benefit of this disclosure.

In certain exemplary embodiments of the pick-up truck stowable access step assemblies disclosed here, which employ hollow longitudinal tubes as described above, various components of the assemblies can be packaged in (i.e., mounted or otherwise positioned at least partially inside) such structural tube members. For example, all or portions of a latching mechanism and/or an electric motor drive mechanism can be packaged inside a stationary or moveable center rail. Such packaging provides good space efficiency as well as protection from road debris, inclement weather, etc. Optionally, convoluted rubber boots or the like can be used for exposed areas to protect the sliding rail(s) from dirt, mud, debris and the affects of salt. Numerous alternative packaging and protection designs will be readily apparent to those of ordinary skill in the art given the benefit of this disclosure. For example, wiper seals can be used to remove debris from the siding rail(s) and a bottom splash guard can be used for further debris protection.

Certain exemplary embodiments of the pick-up truck stowable access step assemblies further comprise an extension control feature to assist or moderate the feel of or required force for deployment or stowing of the access step. Such extension control feature may be used in manual embodiments of the stowable access step assemblies and in power driven embodiments. In certain exemplary embodiments the extension control feature comprises a damper, e.g., a gas strut or the like, and/or a biasing member, such as a compression spring or the like. Optionally, the damper end of biasing member can be combined with integrated into a single component, thereby potentially decreasing complexity, potential failure modes, size and/or cost. For example, a damper strut and a compression spring can be built into one component, thereby decreasing complexity and potential failure modes. In embodiments employing first and second mounting structures such as described above, with a movable frame carrying the access step, struts and/or compression springs or other such components can be connected to the movable frame, e.g., a cross-member of such moveable frame. In certain such embodiments struts and/or compression springs can extend between a cross-member of the second (i.e., movable) mounting structure and the truck body or the first mounting structure. It should be understood that all references here to the truck “body” are intended to mean any or all structural elements of the truck, such as a unibody, a structural member of a body-on-frame design, etc. Numerous alternative designs for this extension control feature will be readily apparent to those of ordinary skill in the art given the benefit of this disclosure.

As disclosed above, certain exemplary embodiments of the pick-up truck stowable access step assemblies comprise a release mechanism to release the access step from its stowed position. Numerous suitable release mechanisms will be readily apparent to those skilled in the art given the benefit of this disclosure. In addition to the latching and release mechanisms described above, exemplary suitable mechanisms include cable release mechanisms similar to those used for hood latching systems in pickup trucks and other vehicles. Such cable release mechanisms are well-known to those skilled in the art and provide advantages such as flexibility in packaging the release feature, i.e., including flexibility in positioning the release handle remotely from the access step, e.g., at a location inside the passenger compartment or outside the passenger compartment. Additional advantages of such cable release mechanisms include good familiarity amongst repair facilities, readily available parts manufacturers, robust designs, etc. Other suitable alternative latching and release mechanisms include, for example, push-to-release mechanisms, e.g., mechanisms similar to those used in foot-operated manual park brake systems. Such release mechanisms can, in at least certain embodiments, eliminate the need for an external release mechanism.

The durability and strength of the stowable access step assemblies will be a design feature well within the ability of those of ordinary skill in the art given the benefit of this disclosure. In general, the required durability and strength—or robustness—of the stowable access step assemblies will depend largely on the particular application. In certain exemplary embodiments the stowable access step assemblies is sufficiently robust to bear at least a 300 pound load with less than 15 mm vertical deflection and less than 1.5 mm deflection set, i.e., permanent vertical deflection. In certain exemplary embodiments the stowable access step assemblies is sufficiently robust to bear at least a 400 pound load with less than 15 mm vertical deflection and less than 1.5 mm deflection set. In certain exemplary embodiments the stowable access step assemblies is sufficiently robust to bear at least a 500 pound load with less than 15 mm vertical deflection and less than 1.5 mm deflection set. In certain highly robust embodiments the stowable access step assemblies is sufficiently robust to bear at least a 600 pound load with less than 15 mm vertical deflection and less than 1.5 mm deflection set.

Referring now to FIGS. 1 and 2, pick-up truck stowable access step assembly 10 is seen to comprise an access step 12 integral with access step mounting members 14, 16. Mounting members 14, 16 are components of deployment structure 18 which is configured to integrate with a pick-up truck, specifically, under the cargo bed of the pick-up truck. Stowable access step 12 has tread portion 20 dimensioned to support at least one human foot. Specifically, deployment structure 18 comprises first mounting structure 22 configured in to be fixedly integrated with the pickup truck body, more specifically, with the cargo bed of the pickup truck. Deployment structure 18 also comprises second mounting structure 23 slidably mounted to first mounting structure 22 four movement relative to the first mounting structure. More specifically, in the illustrated embodiment, first mounting structure 22 is seen to comprise a first stationary longitudinal tube 24, a second stationary longitudinal tube 26 that is spaced from and parallel to the first stationary longitudinal tube, and cross-members 28, 30 interconnecting the first and second stationary longitudinal tubes. Second mounting structure 23 is seen to comprise a first extendable longitudinal tube 32, a second extendable longitudinal tube 34 that is spaced from and parallel to the first extendable longitudinal tube 32, and cross-members 33, 35. The first and second extendable longitudinal tunes are slidably mounted in the first and second stationary longitudinal tubes, respectively, for back-and-forth longitudinal movement of the second mounting structure 23 relative to the first mounting structure 22. In this way, the access step can be deployed and returned to its stowed position. Access step 12 is mounted in fixed orientation to the second mounting structure 23. It is mounted for substantially horizontal, lateral movement (see arrow 25) between the extended position and its stowed position. In the embodiment illustrated in FIGS. 1 and 2, a mirror image stowable access step assembly (not shown) is provided on the opposite side of the cargo bay.

It can be seen that the various longitudinal tubes in the illustrated embodiment comprise square cross-section tubes. By way of example, the travel distance of the access step between its deployed and stowed positions may be about 5 inches. By way of example, again, the extendable longitudinal tubes may have an outside dimension of 1¼ inch on each side, with a ⅛ inch wall thickness, and the stationary longitudinal tube is may have an outside dimension of 1½ inch on each side, with a ⅛ inch wall thickness, such that the 1¼ inch inside dimension of the stationary longitudinal tubes is closely sized to receive the extendable longitudinal tubes. The stationary longitudinal tubes can be mounted or otherwise integrated into the body of a pickup truck in any suitable fashion. In the illustrated embodiment in FIGS. 1 and 2 stationary longitudinal tube 24 is mounted by means of inner mount 36 and outer mount 37. Corresponding mounting brackets (not shown) can be used for the second stationary longitudinal tube 26. Also in the illustrated embodiment, bearings are provided to facilitate sliding motion of the extendable tubes. Specifically, lower bearing 40 and upper bearing 42 are provided for the tube pair on the left (as seen in FIG. 1) and a corresponding pair of bearings 44, 46 is provided for the tube pair on the right.

The illustrated embodiment of FIGS. 1 and 3 further comprises an extension control feature to assist or moderate the feel of or required force for deployment or stowing of the access step. Specifically, strut 50 and compression spring 52 are mounted between cross-member 28 of the first mounting structure 22 and cross-member 36 of the second mounting structure 23.

Pick-up truck stowable access step assembly 10 is seen to further comprise latch and release mechanism 70 mounted to stationary longitudinal tubes 24, 26. Mechanism 70 comprises release lever or handle 72 positioned to be convenient for operation by hand or foot to release latch 74. Handle 72 is pivotably mounted at pivot 71 and a corresponding pivot on the opposite side. Release latch 74 is biased to the latching position, e.g., by spring (not shown) at the pivot. In the latching position free end 76 extends through hole 77 in the upper surface 78 of stationary tube 26 into a corresponding recess 79 (e.g., a hole or detent) in (i.e., in or through) the upper surface 80 of extendable tube 32. The release mechanism is pivoted such that pressing release lever 72 downwardly raises latch 74 upwardly out of recess 79 to permit the access step to be deployed to its extended position. Upon the access step being returned to its stowed position, the latch reengages recess 79 through hole 77 to hold the access step in the stowed position. Numerous alternative designs for release mechanisms suitable for this or different embodiments if the stowable access step assemblies will be readily apparent to those of ordinary skill in the art given the benefit of this disclosure.

As best seen in FIG. 2 and in FIGS. 4A and 4B, access step 12 in the retracted or stowed position extends partially into a recess 56 under exterior body panel 58 of the pickup truck cargo bay, defined at least in part by inner sheet metal 60 supported by support members 62. In the embodiment illustrated in FIGS. 4A and 4B, the stowable access step 12 is seen to be configured to form, especially in the stowed position, a portion or rearward extension of the fixed running board 112 of the pick-up truck. Such embodiments provide good design aesthetics and functionality.

Referring now to FIG. 3, a power driven embodiment 100 of the pick-up truck stowable access step assembly is seen to comprise many of the same components as the embodiment 10 of FIGS. 1 and 2. The same reference numbers are used in FIG. 3 and FIGS. 1 and 2 for components which are substantially the same. The embodiment of FIG. 3 comprises an electric motor 102 mounted conveniently to cross-member 28 and powered by the pick-up truck's 12 volt power system. Alternatively, an independent power source can be used. Drive force generated by motor 102 is transmitted by gearbox 104 to lead screw 106. Position sensor 108 generates a signal corresponding to the position of mounting structure 23 and, therefore, of stowable access step 12. Alternatively or in addition, one or more limit stops can be used to generate a signal corresponding to the limit of travel of mounting structure 23 at either or both ends (and optionally at intermediate positions) of its travel range between the fully extended and fully stowed positions. Actuation of the motor 102 can be controlled by wireless switch, e.g., a switch integrated into a wireless key fob which is also operative to lock and unlock the doors of the passenger compartment of the pick-up truck or by a separate device. Alternatively or in addition, actuation of the motor 102 can be controlled by a hard-wired switch, such as remote switch 108. A non-remote switch also may be provided. Switch 108 is “remote” meaning that it is not directly mounted to any other component of the stowable access step assembly.

It should be understood that this disclosure includes all feasible mix-and-match combinations of the various alternative versions and designs mentioned above for the several components and features of the stowable access step assemblies disclosed here. Although the invention has been described in connection with various specific embodiments, those skilled in the art will appreciate that various adaptations and modifications may be made without departing from the spirit and scope of the invention as set forth in the following claims. In general, unless expressly stated otherwise, all words and phrases are used above and in the following claims have all of their various different meanings, including, without limitation, any and all meaning(s) given in general purpose dictionaries, and also any and all meanings given in science, technology, medical or engineering dictionaries, and also any and all meanings known in the relevant industry, technological art or the like. Thus, where a term has more than one possible meaning, all such meanings are intended to be included for that term as used here. In accordance with traditional patent practice, the indefinite articles “a” and “an” and the like, mean “one or more” of that item.

We claim:

1. A pick-up truck stowable access step assembly comprising, in combination:
an access step having a tread portion dimensioned to support at least one human foot, and
deployment structure configured to integrate with a pick-up truck, the deployment structure comprising at least one access step mounting member configured for movement relative to a cargo bed of the pick-up truck,
wherein the access step is integral with the access step mounting member of the deployment structure and is moveable therewith between an extended position and a stowed position.

2. The pick-up truck stowable access step assembly of claim 1 wherein the travel distance between the stowed position and the extended position is at least 4″.

3. The pick-up truck stowable access step assembly of claim 1 further comprising a deployment-hold mechanism operative to bias the access step in the extended position, comprising at least a compression spring which is compressed when the access step is in the stowed position.

4. The pick-up truck stowable access step assembly of claim 3 wherein the deployment-hold further comprises at least one of the group consisting of a strut and a stop surface.

5. The pick-up truck stowable access step assembly of claim 1 wherein the deployment structure comprises a first mounting structure configured to be fixedly integrated with the bed of a pick-up truck and a second mounting structure mounted to the first mounting structure for movement relative to the first mounting structure, the access step mounting member being at least a component of the second mounting structure.

6. The pick-up truck stowable access step assembly of claim 5 further comprising:
a locking mechanism operative to releasably hold the second mounting structure to the first mounting structure in the stowed position, and
a foot-operable release mechanism comprising a release lever mounted to the second mounting structure and operative to release the second mounting structure from the stowed position.

7. The pick-up truck stowable access step assembly of claim 5 further comprising an electric motor and a drive member driven by the motor and operably connected to the second mounting structure to move the mounting structure between the extended position and a stowed position upon actuation of the motor.

8. The pick-up truck stowable access step assembly of claim 7 further comprising a gearbox, wherein the drive member is a lead screw, the gearbox being operably connected between the motor and the lead screw to control at least the direction of driven movement of the second mounting structure.

9. The pick-up truck stowable access step assembly of claim 7 further comprising a sensor operative to generate a signal corresponding to the movement or position of the second mounting structure.

10. The pick-up truck stowable access step assembly of claim 7 wherein the motor is actuatable at least by at least one of a hand-operable switch hard-wired to a power source for the motor and a wireless switch.

11. The pick-up truck stowable access step assembly of claim 5 wherein the first mounting structure comprises a stationary rail and the second mounting structure comprises a sliding rail mounted for back-and-forth sliding movement relative to the stationary rail for deployment and stowing of the stowable access step.

12. The pick-up truck stowable access step assembly of claim 5 wherein the first mounting structure comprises
a first stationary longitudinal tube,
a second stationary longitudinal tube spaced from and parallel to the first stationary longitudinal tube,
at least two cross-members interconnecting the first and second stationary longitudinal tubes,
and the second mounting structure further comprises
a first extendable longitudinal tube, and
a second extendable longitudinal tube spaced from and parallel to the first extendable longitudinal tube,
wherein the first and second extendable longitudinal tubes are slidably mounted to the first and second stationary longitudinal tubes, respectively, for longitudinal movement of the first and second extendable longitudinal tubes relative to the first and second stationary longitudinal tubes.

13. The pick-up truck stowable access step assembly of claim 12 wherein the first and second stationary longitudinal tubes comprise square cross-section tubes, and the first and second extendable longitudinal tubes comprise square cross-section tubes slidably received longitudinally into the first and second stationary longitudinal tubes, respectively.

14. The pick-up truck stowable access step assembly of claim 13 further comprising bearings operatively interposed between the first mounting structure and the second mounting structure.

15. The pick-up truck stowable access step assembly of claim 5 further comprising at least one of a compression spring and a strut interconnecting the first mounting structure and the second mounting structure.

16. The pick-up truck stowable access step assembly of claim 5 wherein the access step is mounted in fixed orientation relative to the second mounting structure.

17. A pick-up truck comprising, in combination:
a cargo bed;
a stowable access step assembly comprising an access step mounted at the cargo bed for movement between a stowed position and an extended position, having a tread portion dimensioned to receive at least one human foot,
wherein the access step in the extended position is sufficiently robust to bear at least a 300 pound load applied downwardly on the tread portion.

18. The pick-up truck of claim 17 wherein the access step is mounted for substantially horizontal, lateral movement between the extended position and the stowed position.

19. The pick-up truck of claim 17 wherein the access step in the extended position is sufficiently robust to bear at least a 500 pound load with less than 15 mm vertical deflection and less than 1.5 mm permanent vertical deflection.

20. The pick-up truck of claim 17 further comprising a second stowable access step assembly comprising a second access step mounted at the cargo bed for movement between a stowed position and an extended position, having a tread portion dimensioned to receive at least one human foot, the second access step in the extended position being sufficiently robust to bear at least a 300 pound load applied downwardly on the tread portion, wherein:
the stowable access step is mounted at a first side of the cargo bed for substantially horizontal, lateral movement between the stowed position and the extended position, and
the second stowable access step is mounted at a second side of the cargo bed for substantially horizontal, lateral movement between the stowed position and the extended position.

21. The pick-up truck of claim 17 further comprising a running board extending fore-and-aft along at least a portion of the cargo bed, wherein the stowable access step is configured to form, in the stowed position, a portion of the running board.
